(19) United States
(12) Patent Application Publication
(10) Pub. No.: US 2025/0165704 A1
(43) Pub. Date: May 22, 2025

(54) TABLE EDITING

(71) Applicant: Beijing Zitiao Network Technology Co., Ltd., Beijing (CN)

(72) Inventors: Qinghong Chen, Beijing (CN); Andi Guan, Beijing (CN)

(21) Appl. No.: 18/952,349

(22) Filed: Nov. 19, 2024

(30) Foreign Application Priority Data
Nov. 21, 2023 (CN) 202311558338.4

(51) Int. Cl. G06F 40/177

(52) U.S. Cl. CPC G06F 40/177

(57) ABSTRACT

According to embodiments of the disclosure, a method, apparatus, device and storage medium for table editing are provided. The method includes: in response to detecting an input operation on a target index field in a target table, providing at least one recommended index field in the target table; inserting the at least one recommended index field in the target table. Thus, assistance may be provided to the user to quickly create and refine the table.

### CROSS-REFERENCE

The present disclosure claims priority to Chinese Patent Application No. 202311558338.4, entitled “Method, Apparatus, Device and Storage Medium for Table Editing” and filed Nov. 21, 2023, the disclosures of which is incorporated herein by reference in its entirety.

### FIELD

Example embodiments of the present disclosure generally relate to the computer field, and more particularly, to table editing.

### BACKGROUND

With the rapid development of Internet technologies, various applications have become an important tool in people's daily life. Different applications have different functions, and users can implement specific services through specific applications with specific functions. In some scenarios, users need to edit or process various types of contents, including documents, messages, calendars, schedules, tasks, audio, video, images, and the like.

### SUMMARY

In a first aspect of the present disclosure, a method for table editing is provided. The method comprises: in response to detecting an input operation on a target index field in a target table, providing at least one recommended index field in the target table; inserting the at least one recommended index field in the target table.

In a second aspect of the present disclosure, an apparatus for table editing is provided. The apparatus comprises: a recommending module configured to provide, in response to detecting an input operation on a target index field in a target table, at least one recommended index field in the target table; and an inserting module configured to insert the at least one recommended index field in the target table.

In a third aspect of the present disclosure, an electronic device is provided. The electronic device comprises: at least one processing unit; and at least one memory, coupled to the at least one processing unit and storing instructions executed by the at least one processing unit. The instructions, when executed by the at least one processing unit, cause the electronic device to perform the method according to the first aspect of the present disclosure.

In a fourth aspect of the present disclosure, a computer readable storage medium is provided. The medium stores a computer program thereon, which may be executed by a processor to implement the method according to the first aspect of the present disclosure.

It should be understood that what is described in this Summary is not intended to identify key features or essential features of the implementations of the present disclosure, nor is it intended to limit the scope of the present disclosure. Other features disclosed herein will become easily understandable through the following description.

### BRIEF DESCRIPTION OF THE DRAWINGS

The above and other features, advantages, and aspects of respective implementations of the present disclosure will become more apparent from the following detailed description with reference to the accompanying drawings. The same or similar reference numerals represent the same or similar elements throughout the figures, where:

FIG. 1 illustrates a schematic diagram of an example environment in which embodiments of the present disclosure can be implemented;

FIGS. 2-6 illustrate schematic diagrams of example user interfaces for table editing according to some embodiments of the present disclosure;

FIGS. 7A and 7B illustrate schematic diagrams of example user interfaces for table editing according to some embodiments of the present disclosure;

FIG. 8 shows a flowchart of a process for table editing according to some embodiments of the present disclosure;

FIG. 9 shows a flowchart of a process for table editing according to some embodiments of the present disclosure;

FIG. 10 shows a schematic structural block diagram of an apparatus for table editing according to some embodiments of the present disclosure; and

FIG. 11 illustrates a block diagram of an electronic device which is suitable to implement one or more embodiments of the present disclosure.

### DETAILED DESCRIPTION

The embodiments of the present disclosure will be described in more detail with reference to the accompanying drawings, in which some embodiments of the present disclosure have been illustrated. However, it should be understood that the present disclosure can be implemented in various manners, and thus should not be construed to be limited to embodiments disclosed herein. On the contrary, those embodiments are provided for the thorough and complete understanding of the present disclosure. It should be understood that the drawings and embodiments of the present disclosure are only used for illustration, rather than limiting the protection scope of the present disclosure.

As used herein, the term “comprise” and its variants are to be read as open terms that mean “include, but is not limited to.” The term “based on” is to be read as “based at least in part on.” The term “one embodiment” or “the embodiment” is to be read as “at least one embodiment.” The term “some embodiments” is to be read as “at least some embodiments.” Other definitions, explicit and implicit, might be further included below.

As used herein, unless explicitly stated otherwise, performing a step “in response to A” does not mean that the step is performed immediately after “A”, but may include one or more intermediate steps.

It is to be understood that the data involved in this technical solution (including but not limited to the data itself, data acquisition, use, storage or deletion) should comply with the requirements of corresponding laws and regulations and relevant provisions.

It is to be understood that, before applying the technical solutions disclosed in respective embodiments of the present disclosure, the user should be informed of the type, scope of use, and use scenario of the personal information involved in the present disclosure in an appropriate manner in accordance with relevant laws and regulations, and user authorization should be obtained, wherein the user may include any type of rights holder, such as an individual, an enterprise, and a group.

For example, in response to receiving an active request from the user, prompt information is sent to the user to explicitly inform the user that the requested operation would acquire and use the user's personal information. Therefore, according to the prompt information, the user may decide on his/her own whether to provide the personal information to the software or hardware, such as electronic devices, applications, servers, or storage media that perform operations of the technical solutions of the present disclosure.

As an optional but non-limiting implementation, in response to receiving an active request from the user, the way of sending the prompt information to the user may, for example, include a pop-up window, and the prompt information may be presented in the form of text in the pop-up window. In addition, the pop-up window may also carry a select control for the user to choose to “agree” or “disagree” to provide the personal information to the electronic device.

It is to be understood that the above process of notifying and obtaining the user authorization is only illustrative and does not limit the implementations of the present disclosure. Other methods that satisfy relevant laws and regulations are also applicable to the implementations of the present disclosure.

As discussed above, various applications have become an important tool in people's daily life. Different applications have different functions, and users may implement specific services through specific applications with specific functions. In some scenarios, users may need to edit and process various types of contents, e.g., tables. Tables are widely applied because they can make statistics on and classify data.

In general, a table may include a plurality of fields, wherein each field may be used as a dimension for statistics and/or analyses. When the user performs data statistics and/or analysis through a table, a plurality of fields may be added as needed. Due to the complexity and diversity of scenarios in which data statistics and/or analysis needs to be performed, users do not understand which fields need to be added when creating a table for data statistics and/or analysis, thereby affecting the use effect of the table.

In the embodiments of the present disclosure, a solution for table editing is proposed, which is intended to assist a user in quickly creating and completing a table by providing a recommended index field to the user. In this solution, a terminal device, in response to detecting an input operation on a target index field in a target table, provides at least one recommended index field in the target table; and inserts the at least one recommended index field in the target table. Thus, it is possible to assist the user in quickly creating and completing the table.

As used herein, the term “index field” refers to one dimension in which statistics and/or analysis may be made. In some embodiments, one (or more) index field(s) may be added to one (or more) cell(s) of the first row/column. In some complex tables, one (or more) index field(s) may also be added to other positions in the table. The present disclosure is not limited in this respect. As used herein, an “index field” may also sometimes be referred to simply as a “field”.

### Example Environment

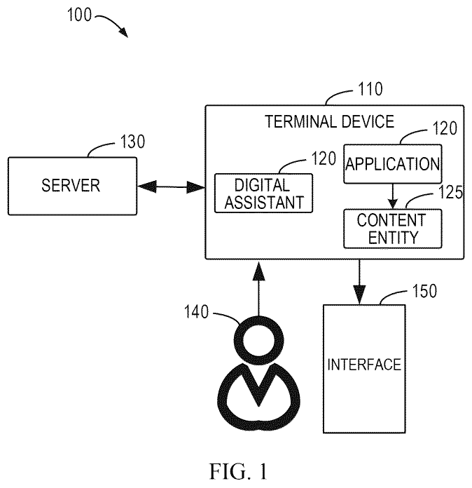

FIG. 1 illustrates a schematic diagram of an example environment 100 in which the embodiments of the present disclosure can be implemented. In this example environment 100, one or more applications 120-1, 120-2, . . . , 120-N are installed in a terminal device 110. For ease of discussion, the applications 120-1, 120-2, . . . , 120-N may be collectively or individually referred to as the applications 120. A user 140 may interact with the application 120 via the terminal device 110 and/or an attachment device of the terminal device 110.

In some embodiments, the application 120 may be downloaded, installed on the terminal device 110. In some embodiments, the application 120 may also be accessed in other manners, such as web page access. In the environment 100 of FIG. 1, in response to the application 120 being started, the terminal device 110 may present an interface 150 of the application 120.

The applications 120 include, but are not limited to, one or more of: chat applications (also known as instant messaging applications), document applications, audio and video conferencing applications, mail applications, task applications, calendar applications, objective and key result (OKR) applications, and so forth. Although a single application is shown in FIG. 1, in practice, a plurality of applications may be installed on the terminal device 110. In some embodiments, the application 120 may include a multifunctional collaboration platform, such as an office collaboration platform (also referred to as an office suite). Such a multifunctional collaboration platform can provide integration of multiple types of applications or components to facilitate people to perform activities such as office and communication. In a multifunctional collaboration platform, people can start different applications or components according to needs to complete processing, sharing, communication and the like of corresponding content entities.

The application 120 may provide a content entity 125 (e.g., the application 120-1 may provide a content entity 125-1, the application 120-2 may provide a content entity 12-2, . . . , the application 120-N may provide a content entity 125-N, wherein the number N of the content entities 125 may be equal to the number N of the applications 120). The content entity 125 may be a content instance created by the user 140 or other user on the application 120. For example, depending on the type of the application 120, the content entity 125 may be a document (e.g., a word document, a pdf document, a presentation, a tabular document, etc.), a mail, a message (e.g., a session message on an instant messaging application), a calendar, a schedule, a task, a project entity, an audio, a video, an image, or the like.

In some embodiments, the terminal device 110 communicates with a server 130 to enable provisioning of services to the application 120. The terminal device may be any type of mobile terminal, fixed terminal, or portable terminal, including a mobile handset, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals for these devices, or any combination thereof. In some embodiments, the terminal device 110 can also support any type of interface for a user (such as a “wearable” circuit, etc.). The server 130 may be various types of computing systems/servers capable of providing computing power, including, but not limited to, mainframes, edge computing nodes, computing devices in a cloud environment, and the like.

It should be understood that the structure and function of the environment 100 are described for exemplary purposes only, and are not intended to imply any limitation on the scope of the present disclosure.

### Example Processes

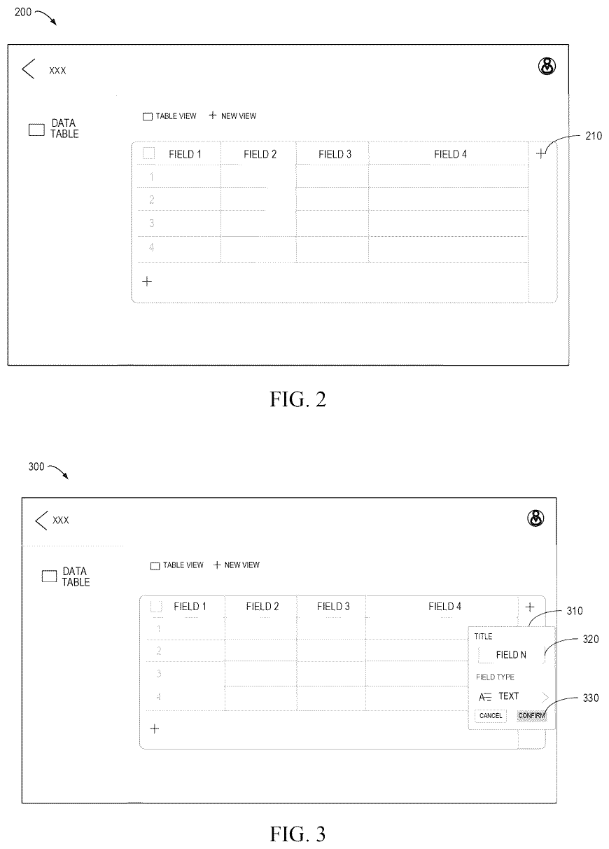

For a better understanding of the respective embodiments of the present disclosure, reference is made to example user interfaces 200 to 700 shown in FIGS. 2 to 7 in the example embodiments below. It should be understood that the user interfaces shown in FIGS. 2 to 7 are merely examples, and various designs may actually exist. For example, individual graphical elements and/or controls in the user interface may have different arrangements and different visual representations, wherein one or more of the elements and/or controls may be omitted or replaced, and one or more other elements and/or controls may also be present. In addition, any suitable content may be included in the user interface. The scope of the present disclosure is not limited in this respect.

Further, the user may implement switching and jumping of the user interface by activating a control/entry in each user interface. It should be understood that the logic for switching and jumping may be randomly set. For example, in an example embodiment, the user jumps from a first user interface to a second user interface by activating the control. In other embodiments, the user may jump from the first user interface to a third user interface by activating another control. The present disclosure is not limited in this respect. It should also be understood that although multiple user interfaces are described in one particular embodiment, any user interface described in this disclosure may be implemented and protected independently as a separate embodiment.

In the example embodiments of the present disclosure, the example user interfaces 200 to 700 may be implemented at the terminal device 110. For ease of discussion, the example user interfaces 200 to 700 will be described with reference to the environment 100 of FIG. 1.

In operation, the terminal device 110 detects an input operation for a field of a target table. If the terminal device 110 detects an input operation for a target index field, at least one recommended index field is provided in the target table. In this manner, at least one candidate field may be automatically recommended to the user in response to an input operation of the user, so as to assist the user in creating the table. In other words, according to various embodiments of the present disclosure, the intention of the user may be perceived through the user interaction behavior, thereby assisting the user in completing subsequent operations.

Further, the terminal device 110 further provides a confirmation control or a cancellation control for the at least one recommended index field, to select to confirm or cancel the insertion of the at least one recommended index field in the target table. In this way, whether the previous recommendation behavior is appropriate and whether the recommendation result meets the user's real intention may be confirmed through further interaction with the user.

In some embodiments, the target table may be a tabular document. Alternatively, in some embodiments, the target table may be a database table, an online table, or a spreadsheet. Alternatively, in some embodiments, the target table is a table inserted in a common document. It should be understood that, in actual operation, taking a database table as an example, the database table is usually used to complete more complex analysis and statistics work. Therefore, the difficulty of creating the database table will be greater for the user. Accordingly, various embodiments of the present disclosure are particularly helpful in helping users complete the creation of database tables. However, it should be understood that the application scenarios of various embodiments of the present disclosure are not limited to a database table. In other words, the application scenarios of various embodiments of the present disclosure include, but are not limited to, spreadsheets, online tables, and other types of tables.

For the user, in the initial stage of table creation, it is usually necessary to determine a plurality of index fields. When the table to be created includes a plurality of index fields, the creation process of the table has a certain difficulty for the user. According to various embodiments of the present disclosure, it is possible to assist the user in inserting an appropriate index field to quickly create and refine a table.

Next, various embodiments of the present disclosure will be described in detail with reference to an example user interface.

In some embodiments, the terminal device 110 detects an input operation for an index field of a target table. With reference to an example user interface 200 shown in FIG. 2, the example user interface 200 shows an editing interface of a target table named XXX. In the example user interface 200, the user may edit operations on the target table, including, but not limited to, deletion, modification, addition, insertion, and the like.

In some embodiments, the table may include a plurality of index fields. Further, in some embodiments, attributes such as the type and the name of the index field supported by the table may be limited. In some embodiments, the index fields supported by the table include, but are not limited to: multi-line text, a single choice, a multiple choice, a person, a date, an attachment, a number, a check box, a hyperlink, a phone number, a rating, a mail, a modifier, a creator, a group, a progress, a currency, a creation time, a last update time, a button, auto numbering, a barcode, a geographic location, and the like. Correspondingly, in some embodiments, the index fields not supported by the table include, but are not limited to, a unidirectional association, a bidirectional association, a lookup reference, a formula, and a flow field.

In some embodiments, the user may trigger an input of an index field in the example user interface 200. In some embodiments, the input operation of the index field includes: an editing operation on an existing index field in the target table. In the example user interface 200 shown in FIG. 2, the user may edit the existing fields 1 to 4.

Alternatively, in some embodiments, the input operation of the field includes an operation of adding an index field in the target table. In the example interface 200 shown in FIG. 2, an insertion control 210 is included. In response to activation of the insertion control 210, the user may insert at least one target index field. Alternatively, the user may trigger insertion of the target index field by clicking a right mouse button or the like.

In some embodiments, if an input operation for the target index field is detected, the terminal device 110 provides at least one recommended index field in the target table.

In the example embodiment of FIG. 2, if the user triggers the insertion control 210 (or triggers a corresponding option in an expanded menu of a mouse right key), the user interface jumps to an example user interface 300 shown in FIG. 3. In the example interface 300, a pop-up window 310 is presented. Through the pop-up window 310, the user may input a target index field, i.e., a field N 320. If the user confirms the insertion of the field N 320, for example, clicks a determination control 330 in the example user interface 300, the terminal device 110 may be triggered to provide at least one recommended index field in the target table.

In some embodiments, in response to detecting the input operation for the target index field, the terminal device 110 presents a recommendation loading state before the at least one recommended index field is determined.

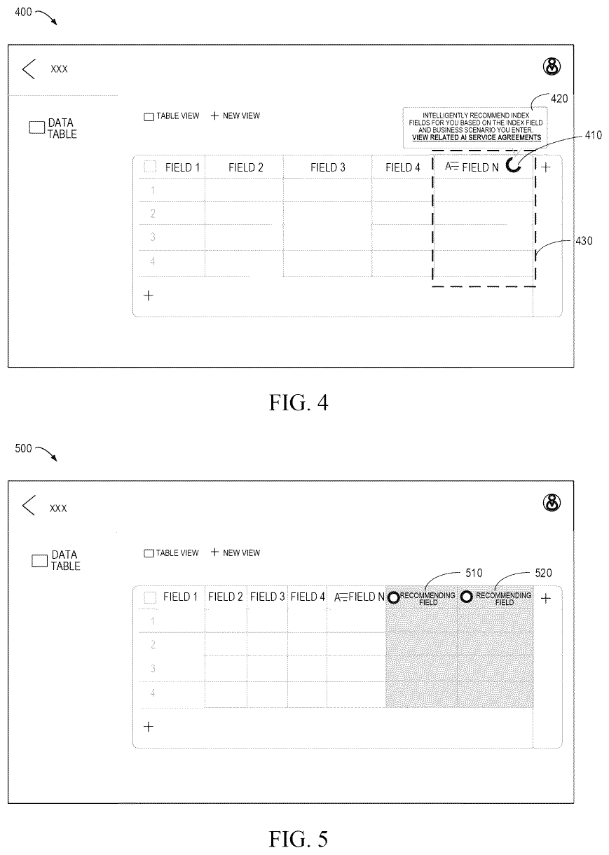

Refer to example user interfaces 300 and 400 shown in FIG. 3-4. Specifically, in response to the user clicking on the determination control 330 in the example user interface 300, the user interface jumps from the example user interface 300 to the example user interface 400.

In the example embodiment of FIG. 4, a loading icon 410 is presented in the example user interface 400 to prompt the user that the terminal device 110 is generating a recommended index field. Alternatively or additionally, in the example embodiment of FIG. 4, the example user interface 400 also presents prompt information 420-“Intelligently recommend index fields for you based on the index field and business scenario you enter, view related AI service agreements.” The prompt information 420 may also prompt the user that the terminal device 110 is generating the recommended index field.

In some embodiments, in response to the at least one recommended index field being determined, the terminal device 110 provides at least one recommended index field in the target table. For example, the user interface jumps to an example user interface 600 from the example user interface 400.

In some embodiments, in response to detecting the input operation on the target index field, the terminal device 110 provides at least one placeholder field in the target table before the at least one recommended index field is determined, and in response to the at least one recommended index field being determined, the terminal device 110 replaces the at least one placeholder field with the at least one recommended index field.

Refer to the example user interfaces 300 and 500 shown in FIGS. 3 and 5. Specifically, in response to the user clicking on the determination control 330 in the example user interface 300, the user interface jumps from the example user interface 300 to the example user interface 500.

In the example embodiment of FIG. 5, the terminal device 110 provides at least one placeholder field, such as placeholder fields 510 and 520, in the target table before the at least one recommended index field is determined.

In some embodiments, in response to the at least one recommended index field being determined, the terminal device 110 replaces the at least one placeholder field with the at least one recommended index field. For example, the user interface jumps to the example user interface 600 from the example user interface 500.

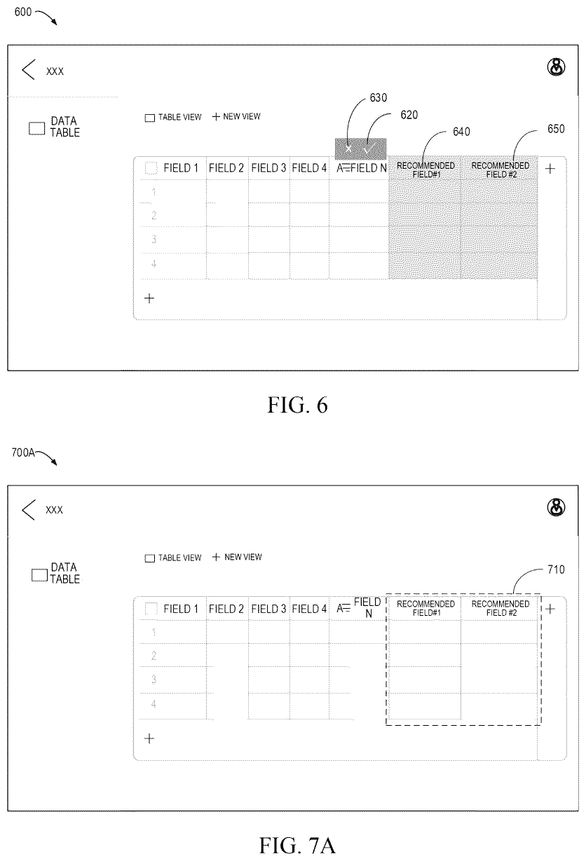

In some embodiments, the terminal device 110 inserts the at least one recommended index field after the target index field. Referring to the example user interface 600 shown in FIG. 6, a recommended field #1 640 and a recommended field #2 650 are inserted after the first field (i.e., field N).

In some embodiments, the terminal device 110 creates at least one target data column in the target table, wherein the at least one recommended index field is displayed in the target data column, and a format of the target data column is the same as a format of the data column where the target index field is located. Refer to the example user interface 600 shown in FIG. 6. The terminal device 110 creates two columns of new target data columns in the target table, and the recommended field #1 and the recommended field #1 are displayed in the newly created target data columns. As shown in FIG. 6, the format of the target data column where the recommended field #1 and the recommended field #2 are located is the same as the format of the data column where the target index field (that is, the field N) is located.

In some embodiments, the terminal device 110 provides a confirmation control or a cancellation control for the at least one recommended index field for selection of confirmation or cancellation for the insertion of the at least one recommended index field in the target table.

In some embodiments, the confirmation control or cancellation control is provided in or around the cell where the target index field is located. Refer to the example user interface 600 shown in FIG. 6. In the example user interface 600A, a confirmation control 620 and a cancellation control 630 are presented.

In some embodiments, in response to receiving a trigger for the confirmation control, the terminal device 110 confirms the insertion of the at least one recommended index field in the target table. In the example user interface 600, if the user activates the confirmation control 620, it indicates that the user confirms insertion of the at least one recommended index field in the target table. For example, the user interface jumps to an example user interface 700A from the example user interface 600.

In some embodiments, in response to receiving a trigger for the cancellation control, the terminal device 110 deletes the at least one recommended index field from the target table. In the example user interface 600, if the user activates the cancellation control 630, it indicates that the user declines to insert the at least one recommended index field in the target table. For example, the user interface jumps from the example user interface 600 to an example user interface 700B.

In some embodiments, if an explicit intention of the user to confirm or reject the recommended index field is not detected, a default operation is performed, e.g., to confirm insertion/deletion of the recommended index field. In an example embodiment, if the presentation time of the example user interface 600 reaches a threshold time, the user interface jumps from the example user interface 600 to the example user interface 700A (or 700B).

In some embodiments, the terminal device 110 provides the at least one recommended index field in a first display mode in the target table, and after confirming the insertion of the at least one recommended index field in the target table, the terminal device 110 provides the at least one recommended index field in a second display mode.

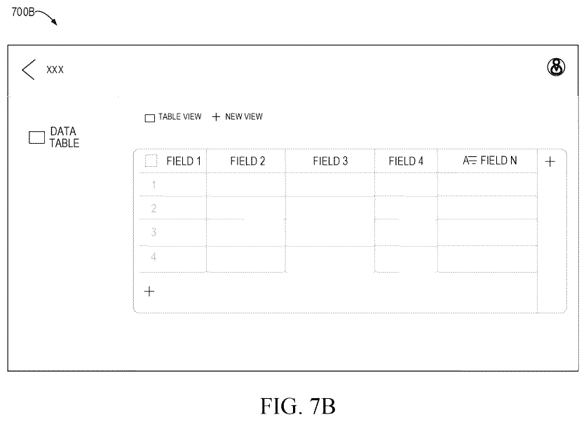

Referring to the example user interface 600 shown in FIG. 6, wherein the recommended fields 640 and 650 are presented in the first display mode, e.g., highlighted. If the user clicks on the confirmation control 620 in the user interface 600 (or the presentation time of the example user interface 600 reaches the threshold time), the user interface is displayed as shown in FIG. 7A, that is, the terminal device 110 provides the at least one recommended index field, such as unhighlighting, in the second display mode.

In some embodiments, the terminal device 110 provides the at least one recommended index field based on the target index field.

Alternatively or additionally, in some embodiments, the terminal device 110 provides the at least one recommended index field based on at least one other field in the target table other than the target index field. Alternatively or additionally, in some embodiments, the terminal device 110 provides the at least one recommended index field based on at least one other field in the target table other than the target index field.

Alternatively or additionally, in some embodiments, the terminal device 110 provides the at least one recommended index field based on field values in the target table. Alternatively or additionally, in some embodiments, the terminal device 110 provides the at least one recommended index field based on a title of the target table. Alternatively or additionally, in some embodiments, the terminal device 110 provides the at least one recommended index field based on a template used by the target table.

In some embodiments, the terminal device 110 determines a field name and a field type of the recommended index field based on the target index field, and provides a corresponding recommended index field based on the determined field name and field type.

In some embodiments, the terminal device 110 may invoke a model to complete the determination of the recommended index field. The model may be a machine learning model, a deep learning model, a learning model, a neural network, or the like. In some embodiments, the model may be based on a large language model (LLM). The large language model can have question-and-answer capabilities by learning from a large number of corpora. The model may also be based on other suitable models.

A prompt may be determined by constructing training data based on the template and provided to the model. The model outputs at least one recommended word based on the prompt. By obtaining the model output, at least one recommended word may be determined.

In some embodiments, a field group template may be configured for a high-frequency scene. Examples of high-frequency scenes include, but are not limited to, projects, tasks, needs, customers, products, orders, employees, and the like. In some embodiments, each field group template includes a certain number of fields, e.g., 10. These high-frequency scenes and their corresponding field group templates may be provided as prompts to the model for the model to generate the at least one recommended word.

In some embodiments, the terminal device 110 determines, based on a data feature of the target table, whether to provide the at least one recommended index field when detecting the input operation of the target index field. In some embodiments, the data feature of the target table is determined based on at least one of: a number of existing index fields in the target table, and a number of existing field values in the target table. As an example, the at least one recommended index field is provided if and only if the quantity of existing index fields and/or the number of existing field values in the target table is less than a threshold quantity (and/or the number of rows of the target table). This is because at this point most tables are in the early stage of creation, and it is predicted that users will have a need to further add fields.

Alternatively or additionally, in some embodiments, the terminal device 110 determines, based on historical interaction behavior of the user editing the target table, whether to provide the at least one recommended index field when detecting an input operation of the target index field. In some embodiments, the historical interaction behavior of the user includes feedback behavior of the user on the historical recommended index field. As an example, if a count that the user continuously or cumulatively rejects the recommended index field exceeds a threshold count during the document activity, at least one referral index field is no longer provided. This is because it is predicted from the user's interaction behavior that the user does not need additional assistance to complete the creation of the table. At this time, to recommend the index field to the user will cause unnecessary disruption to the user.

In some embodiments, if the user deletes some recommended words after determining the recommended index field, it is considered that the user confirms (or cancels) the recommended keyword. Alternatively, in some embodiments, if the user deletes all recommended words after determining the recommended index field, it is considered that the user cancels the recommended keyword. In this way, the operation of recommending the index field is made to better fit the user's real intention.

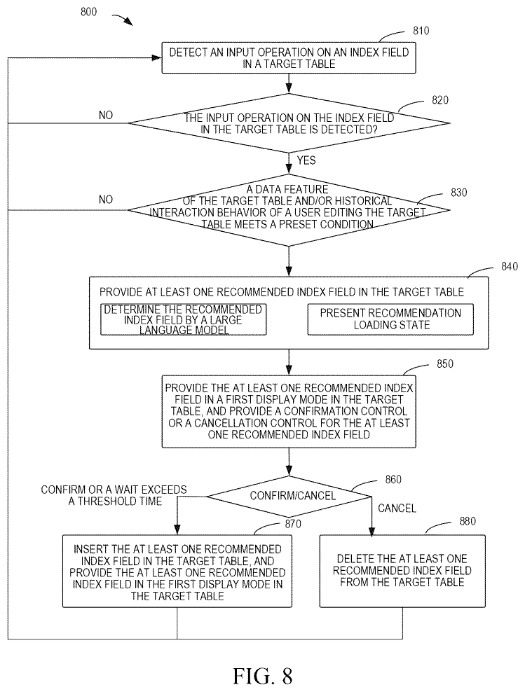

Next, an example embodiment of the present disclosure is further described in conjunction with a flowchart of a method 800 for table editing shown in FIG. 8. The method 800 may be implemented at the terminal device 110.

At block 810, the terminal device 110 detects an input operation for an index field of a target table. At block 820, the terminal device 110 determines whether the input operation for the index field of the target table has been detected.

If the input operation for the index field of the target table is detected (e.g., clicking on the insertion control 210 in the example user interface 200), then at block 830, the terminal device 110 determines that a data feature of the target table and/or historical interaction behavior of the user editing the target table satisfies a preset condition.

Next, if it is determined that the data feature of the target table and/or the historical interaction behavior of the user editing the target table does not satisfy the preset condition, the process returns to block 810. For example, if and only if the quantity of existing index fields and/or the number of existing field values in the target table is greater than or equal to the threshold quantity, and/or the count that the user continuously or cumulatively rejects the recommended index field exceeds the threshold count, at least one recommended index field is no longer provided.

On the contrary, if it is determined that the data feature of the target table and/or the historical interaction behavior of the user editing the target table meet the preset condition, at block 840, the terminal device 110 provides the at least one recommended index field in the target table. For example, if and only if the quantity of existing index fields and/or the number of existing field values in the target table is less than the threshold quantity, and/or the count that the user continuously or cumulatively rejects the recommended index field is less than the threshold count, the operation of providing the at least one recommendation index field is performed.

Further, the terminal device 110 may determine the recommended index field by using the large language model, and/or present the recommended loading state (for example, the user interface display is shown in FIG. 4 or 5).

At block 850, the terminal device 110 provides the at least one recommended index field in the target table in the first display mode, and provides a confirmation control or a cancellation control for the at least one recommended index field, for example, the user interface is displayed as shown in FIG. 6.

At block 860, the terminal device 110 determines whether to cancel the recommended field. In block 870, if the user confirms the recommended index field or waits for more than a threshold time, the terminal device 110 confirms insertion of the at least one recommended index field in the target table, and provides the at least one recommended index field in the target table in the first display mode, for example, the user interface is displayed as shown in FIG. 7A.

In block 870, if the user cancels the recommended index field, at block 880, the terminal device 110 deletes the at least one recommended index field from the target table, for example, the user interface is displayed as shown in FIG. 7B.

In this way, when the user edits the table, an index field may be automatically recommended to the user in response to the user's input, so as to assist the user in quickly creating and refining the table.

### Example Methods

FIG. 9 shows a flowchart of a method 900 for table editing according to some embodiments of the present disclosure. The method 900 may be implemented at the terminal device 110. The method 900 is described below with reference to FIG. 1.

At block 910, in response to detecting an input operation on a target index field in a target table, the terminal device 110 provides at least one recommended index field in the target table.

At block 920, the terminal device 110 inserts the at least one recommended index field in the target table.

In some embodiments, the terminal device 110 provides a confirmation control or a cancellation control for the at least one recommended index field for selection of confirmation or cancellation for the insertion of the at least one recommended index field in the target table.

In some embodiments, in response to receiving the trigger for the confirmation control, the terminal device 110 confirms the insertion of the at least one recommended index field in the target table.

In some embodiments, in response to receiving the trigger for the cancellation control, the terminal device 110 deletes the at least one recommended index field from the target table.

In some embodiments, the input operation of the field comprises: an operation of adding a field in the target table.

In some embodiments, the input operation of the field comprises: an editing operation on an existing field in the target table.

In some embodiments, the terminal device 110 provides the at least one recommended index field further based on at least one of: a target index field, at least one other field in the target table other than the target index field, a field value in the target table, a title of the target table, or a template used by the target table.

In some embodiments, in response to detecting the input operation for the target index field, the terminal device 110 presents a recommendation loading state before the at least one recommended index field is determined, and in response to the at least one recommended index field being determined, the terminal device 110 provides the at least one recommended index field in the target table.

In some embodiments, in response to detecting the input operation on the target index field, the terminal device 110 provides at least one placeholder field in the target table before the at least one recommended index field is determined, and in response to the at least one recommended index field being determined, the terminal device 110 replaces the at least one placeholder field with the at least one recommended index field.

In some embodiments, the terminal device 110 inserts the at least one recommended index field after the target index field.

In some embodiments, the terminal device 110 creates at least one target data column in the target table, wherein the at least one recommended index field is displayed in the at least one target data column, and a format of the at least one target data column is the same as a format of a data column where the target index field is located.

In some embodiments, the terminal device 110 determines a field name and a field type of the at least one recommended index field based on the target index field; and provides the at least one recommended index field based on the field name and the field type.

In some embodiments, the terminal device 110 provides the at least one recommended index field in a first display mode in the target table, and after confirming the insertion of the at least one recommended index field in the target table, the terminal device 110 provides the at least one recommended index field in a second display mode.

In some embodiments, the terminal device 110, determines whether to provide the at least one recommended index field based on at least one of the following with the input operation on the target index field being detected: a data feature of the target table, or historical interaction behavior of a user editing the target table.

In some embodiments, the data feature of the target table is determined based on at least one of: a number of existing index fields in the target table, a number of existing field values in the target table, and/or wherein the historical interaction behavior of the user comprises: feedback behavior of the user on a historical recommended index field.

In some embodiments, the confirmation control or cancellation control is provided in or around a cell where the target index field is located.

### Example Device and Apparatus

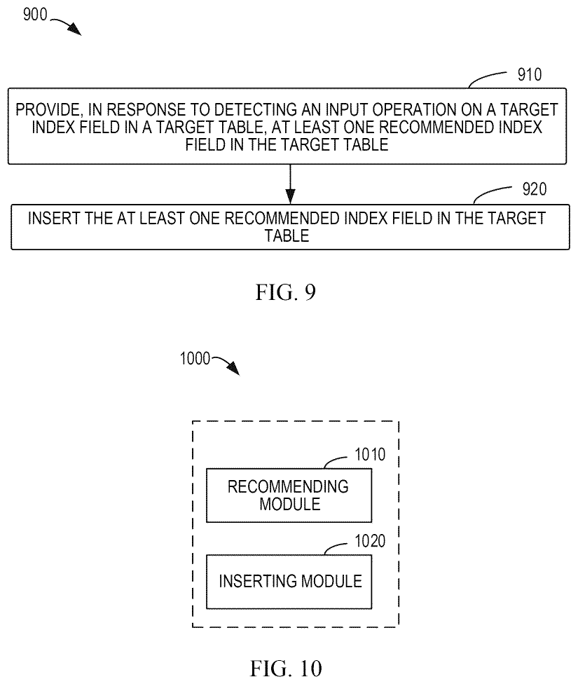

FIG. 10 shows a schematic structural block diagram of an apparatus 1000 for table editing according to some embodiments of the present disclosure. The apparatus 1000 may be implemented or included in the terminal device 110. The various modules/components in the apparatus 1000 may be implemented by hardware, software, firmware, or any combination thereof.

As shown, the apparatus 1000 comprises a recommending module 1010 configured to provide, in response to detecting an input operation on a target index field in a target table, at least one recommended index field in the target table; and an inserting module 1020 configured to insert the at least one recommended index field in the target table.

In some embodiments, the apparatus 1000 further comprises a confirming module configured to provide a confirmation control or a cancellation control for the at least one recommended index field for selection of confirmation or cancellation for the insertion of the at least one recommended index field in the target table.

In some embodiments, the apparatus 1000 further comprises an insertion confirming module configured to confirm insertion of the at least one recommended index field in the target table in response to receiving the trigger for the confirmation control. In some embodiments, the apparatus 1000 further comprises a cancellation confirming module configured to delete the at least one recommended index field from the target table in response to receiving the trigger for the cancellation control.

In some embodiments, the recommending module 1010 is configured to provide the at least one recommended index field further based on at least one of: a target index field, at least one other field in the target table other than the target index field, a field value in the target table, a title of the target table, or a template used by the target table.

In some embodiments, the recommending module 1010 is further configured to: in response to detecting the input operation for the target index field, present a recommendation loading state before the at least one recommended index field is determined; and in response to the at least one recommended index field being determined, provide the at least one recommended index field in the target table.

In some embodiments, the recommending module 1010 is further configured to: in response to detecting the input operation on the target index field, provide at least one placeholder field in the target table before the at least one recommended index field is determined; and in response to the at least one recommended index field being determined, replace the at least one placeholder field with the at least one recommended index field.

In some embodiments, the recommending module 1010 is further configured to insert the at least one recommended index field after the target index field.

In some embodiments, the recommending module 1010 is further configured to create at least one target data column in the target table, wherein the at least one recommended index field is displayed in the at least one target data column, and a format of the at least one target data column is the same as a format of a data column where the target index field is located.

In some embodiments, the recommending module 1010 is further configured to determine a field name and a field type of the at least one recommended index field based on the target index field; and provide the at least one recommended index field based on the field name and the field type.

In some embodiments, the recommended index field generating module 1020 is further configured to provide the at least one recommended index field in a first display mode in the target table. And the apparatus 1000 further comprises: a second displaying module (not shown) configured to, after confirming the insertion of the at least one recommended index field in the target table, provide the at least one recommended index field in a second display mode.

In some embodiments, the apparatus 1000 further comprises a judging module (not shown) configured to, determine whether to provide the at least one recommended index field based on at least one of the following with the input operation on the target index field being detected: a data feature of the target table, or historical interaction behavior of a user editing the target table.

In some embodiments, the data feature of the target table is determined based on at least one of: a number of existing index fields in the target table, a number of existing field values in the target table, and/or wherein the historical interaction behavior of the user comprises: feedback behavior of the user on a historical recommended index field.

In some embodiments, the confirmation control or cancellation control is provided in or around a cell where the target index field is located.

FIG. 10 shows a block diagram of an electronic device 1000 in which one or more embodiments of the present disclosure may be implemented. It should be understood that the electronic device 1000 illustrated in FIG. 10 is merely exemplary and should not constitute any limitation on the functionality and scope of the embodiments described herein. The electronic device 1000 shown in FIG. 10 may be configured to implement the terminal device 110 in FIG. 1.

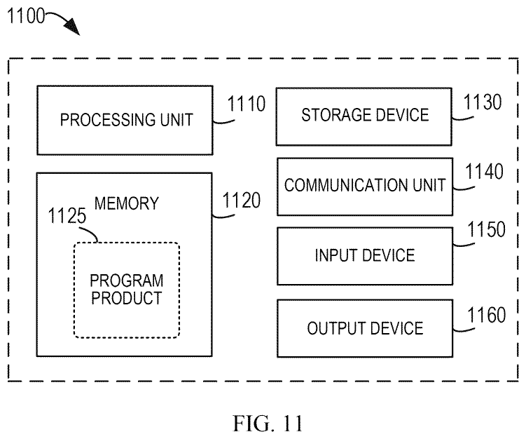

As shown in FIG. 11, the electronic device 1100 is in the form of a general purpose computing device. Components of the electronic device 1100 may include, but are not limited to, one or more processors or processing units 1110, a memory 1120, a storage device 1130, one or more communication units 1140, one or more input devices 1150, and one or more output devices 1160. The processing unit 1110 may be a physical or virtual processor and may execute various processing based on the programs stored in the memory 120. In a multi-processor system, a plurality of processing units executes computer-executable instructions in parallel to enhance parallel processing capability of the electronic device 1100.

The electronic device 1100 usually includes a plurality of computer storage mediums. Such mediums may be any attainable medium accessible by the electronic device 1100, including but not limited to, a volatile and non-volatile medium, a removable and non-removable medium. The memory 1120 may be a volatile memory (e.g., a register, a cache, a Random Access Memory (RAM)), a non-volatile memory (such as, a Read-Only Memory (ROM), an Electrically Erasable Programmable Read-Only Memory (EEPROM), flash), or any combination thereof. The storage device 1130 may be a removable or non-removable medium, and may include a machine-readable medium (e.g., a memory, a flash drive, a magnetic disk) or any other medium, which may be used for storing information and/or data (e.g., training data for training) and be accessed within the computing device 600.

The electronic device 1100 may further include additional removable/non-removable, volatile/non-volatile storage mediums. Although not shown in FIG. 11, there may be provided a disk drive for reading from or writing into a removable and non-volatile disk (e.g., “floppy disk”) and an optical disc drive for reading from or writing into a removable and non-volatile optical disc. In such cases, each drive may be connected to a bus (not shown) via one or more data medium interfaces. The memory 1120 may include a computer program product 1125 having one or more program modules, and these program modules are configured for performing various methods or acts of various implementations of the present disclosure.

The communication unit 1140 implements communication with another computing device via a communication medium. Additionally, functions of components of the electronic device 1100 may be realized by a single computing cluster or a plurality of computing machines, and these computing machines may communicate through communication connections. Therefore, the electronic device 1100 may operate in a networked environment using a logic connection to one or more other servers, a Personal Computer (PC) or a further general network node.

The input device 1150 may be one or more various input devices, such as a mouse, a keyboard, a trackball, a voice-input device, and the like. The output device 1160 may be one or more output devices, e.g., a display, a loudspeaker, a printer, and so on. The electronic device 1100 may also communicate through the communication unit 1140 with one or more external devices (not shown) as required, where the external device, e.g., a storage device, a display device, and so on, communicates with one or more devices that enable users to interact with the electronic device 1100, or with any device (such as a network card, a modem, and the like) that enable the electronic device 1100 to communicate with one or more other computing devices. Such communication may be executed via an Input/Output (I/O) interface (not shown).

According to the example implementations of the present disclosure, a computer-readable storage medium is provided, on which computer-executable instructions are stored, wherein the computer-executable instructions are executed by a processor to implement the method described above. According to the example implementations of the present disclosure, a computer program product is further provided, which is tangibly stored on a non-transient computer-readable medium and includes computer-executable instructions, which are executed by a processor to implement the method described above.

Aspects of the present disclosure are described herein with reference to flowchart illustrations and/or block diagrams of methods, apparatus (systems), and computer program products according to implementations of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods and computer program products according to various implementations of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various implementations of the present disclosure have been presented for purposes of illustration, but are not intended to be exhaustive or limited to implementations disclosed. Many modifications and variations will be apparent to those of ordinary skill in the art without departing from the scope and spirit of the described implementations. The terminology used herein was chosen to best explain the principles of implementations, the practical application or technical improvement over technologies found in the marketplace, or to enable others of ordinary skill in the art to understand implementations disclosed herein.

What is claimed is:

1. A method for table editing, comprising:
in response to detecting an input operation on a target index field in a target table, providing at least one recommended index field in the target table; and
inserting the at least one recommended index field in the target table.

2. The method of claim 1, further comprising:
providing a confirmation control or a cancellation control for the at least one recommended index field for selection of confirmation or cancellation for the insertion of the at least one recommended index field in the target table.

3. The method of claim 2, further comprising:
in response to receiving a trigger for the confirmation control, confirming the insertion of the at least one recommended index field in the target table, or
in response to receiving a trigger for the cancellation control, deleting the at least one recommended index field from the target table.

4. The method of claim 1, wherein the input operation on the target index field comprises:
an operation of adding a field in the target table, or
an editing operation on an existing field in the target table.

5. The method of claim 1, wherein providing at least one recommended index field in the target table comprises:
providing the at least one recommended index field further based on at least one of:
the target index field,
at least one other field in the target table other than the target index field,
a field value in the target table,
a title of the target table, or
a template used by the target table.

6. The method of claim 1, wherein providing the at least one recommended index field in the target table comprises:
in response to detecting the input operation for the target index field, presenting a recommendation loading state before the at least one recommended index field is determined; and
in response to the at least one recommended index field being determined, providing the at least one recommended index field in the target table.

7. The method of claim 1, wherein providing the at least one recommended index field in the target table comprises:
in response to detecting the input operation on the target index field, providing at least one placeholder field in the target table before the at least one recommended index field is determined; and
in response to the at least one recommended index field being determined, replacing the at least one placeholder field with the at least one recommended index field.

8. The method of claim 1, wherein providing the at least one recommended index field in the target table comprises: inserting the at least one recommended index field after the target index field.

9. The method of claim 1, wherein providing the at least one recommended index field in the target table comprises:
creating at least one target data column in the target table, wherein the at least one recommended index field is displayed in the at least one target data column, and a format of the at least one target data column is the same as a format of a data column where the target index field is located.

10. The method of claim 1, wherein providing the at least one recommended index field in the target table comprises:
determining a field name and a field type of the at least one recommended index field based on the target index field; and
providing the at least one recommended index field based on the field name and the field type.

11. The method of claim 1, wherein providing the at least one recommended index field in the target table comprises:
providing the at least one recommended index field in a first display mode in the target table; and
wherein the method further comprises:
after confirming the insertion of the at least one recommended index field in the target table, providing the at least one recommended index field in a second display mode.

12. The method of claim 1, further comprising:
determining whether to provide the at least one recommended index field based on at least one of the following with the input operation on the target index field being detected:
a data feature of the target table, or
historical interaction behavior of a user editing the target table.

13. The method of claim 12, wherein the data feature of the target table is determined based on at least one of: a number of existing index fields in the target table, a number of existing field values in the target table, and/or
wherein the historical interaction behavior of the user comprises: feedback behavior of the user on a historical recommended index field.

14. The method of claim 2, wherein the confirmation control or cancellation control is provided in or around a cell where the target index field is located.

15. An electronic device, comprising:
at least one processing unit; and
at least one memory coupled to the at least one processing unit and storing instructions executable by the at least one processing unit, the instructions, when executed by the at least one processing unit, causing the electronic device to perform acts for table editing, the acts comprising:
in response to detecting an input operation on a target index field in a target table, providing at least one recommended index field in the target table; and
inserting the at least one recommended index field in the target table.

16. The electronic device of claim 15, the acts further comprising:
providing a confirmation control or a cancellation control for the at least one recommended index field for selection of confirmation or cancellation for the insertion of the at least one recommended index field in the target table.

17. The electronic device of claim 16, the acts further comprising:
in response to receiving a trigger for the confirmation control, confirming the insertion of the at least one recommended index field in the target table, or
in response to receiving a trigger for the cancellation control, deleting the at least one recommended index field from the target table.

18. The electronic device of claim 15, wherein the input operation on the target index field comprises:
an operation of adding a field in the target table, or
an editing operation on an existing field in the target table.

19. The electronic device of claim 15, wherein providing at least one recommended index field in the target table comprises:
providing the at least one recommended index field further based on at least one of:
the target index field,
at least one other field in the target table other than the target index field,
a field value in the target table,
a title of the target table, or
a template used by the target table.

20. A non-transitory computer-readable storage medium having a computer program stored thereon, wherein the computer program is executable by a processor to implement acts for table editing, the acts comprising:
in response to detecting an input operation on a target index field in a target table, providing at least one recommended index field in the target table; and
inserting the at least one recommended index field in the target table.
